(19) United States
(12) Patent Application Publication
(10) Pub. No.: US 2018/0149193 A1
(43) Pub. Date: May 31, 2018

(54) METHOD FOR PRODUCING A SPHERICAL BEARING AND ASSOCIATED SPHERICAL BEARING

(71) Applicant: SCHAEFFLER TECHNOLOGIES AG & CO. KG, Herzogenaurach (DE)

(72) Inventors: Christian FORSTNER, Schweinfurt (DE); Sergej SCHWARZ, Nuernberg (DE); Frank BOLTE, Melle (DE)

(73) Assignee: SCHAEFFLER TECHNOLOGIES AG & CO. KG, Herzogenaurach (DE)

(21) Appl. No.: 15/575,956

(22) PCT Filed: May 17, 2016
(86) PCT No.: PCT/DE2016/200234

§ 371 Date: Nov. 21, 2017

(30) Foreign Application Priority Data
May 28, 2015 (DE) 10 2015 209 760.9

(51) Int. Cl. F16C 19/06; B21D 53/10; B21D 22/30; F16C 33/66; F16C 35/06

(52) U.S. Cl. CPC F16C 19/06; B21D 53/10; F16C 2208/02; F16C 33/6659; F16C 35/06; B21D 22/30

(57) ABSTRACT

A spherical bearing an inner ring that can rotate and pivot with respect to an outer ring. A sliding body is placed about the inner ring and inside of the outer ring. The sliding body reduces the friction associated with the relative movement of the inner ring and outer ring. The sliding body has a concave inner surface that contacts the convex outer surface of the inner ring. The sliding body may be made of a polymer composite material to reduce the friction during movement. During assembly, the sliding body is placed about the inner ring, and then the outer ring is placed over the sliding body. To contain the sliding body, the outer ring may be bent or caulked.

### CROSS-REFERENCE TO RELATED APPLICATIONS

This application is the U.S. National Phase of PCT/DE2016/200234 filed May 17, 2016, which claims priority to DE 102015209760.9, filed May 28, 2015, the entire disclosures of which are incorporated by reference herein.

### TECHNICAL FIELD

The disclosure relates to a method for producing a spherical bearing, having an inner ring with a convex curved spherical sliding surface, and an outer ring encompassing the inner ring.

### BACKGROUND

Spherical bearings are used when a bearing must execute pivotal movements, or when two components coupled by means of the spherical bearing are not exactly flush. A conventional spherical bearing is normally composed of an inner ring and an outer ring, which are made of a steel alloy. Alternatively, the bearing rings can also be made of bronze or sintered bronze. The spherical sliding contact surface formed between the inner ring and the outer ring can have a sliding coating, or it can be produced by a surface treatment. The outer ring and the inner ring are either turned from a tube-shaped bar stock, or produced by a forging process, depending on the diameter.

Due to the complex production process, comprising a series of individual steps, the production costs cannot be substantially reduced, even with small nominal diameters.

### SUMMARY

The object of the disclosure is thus to produce a method for the production of a spherical bearing, with which the production costs are reduced.

In order to achieve this object, a method of the type specified in the introduction is provided, having the following steps:

production of the inner ring from a metallic material;

production of a one-piece or two-piece sliding body from a polymer composite material;

production of a cylindrical outer ring from a metallic material; and

insertion of the inner ring and the sliding body into the outer ring, and caulking or folding over the outer ring.

Various embodiments of the invention are based on the knowledge that a spherical bearing can be produced at lower costs in that, instead of a conventional outer ring, normally produced through turning, a one-piece or two-piece sliding body is used, which is produced from a polymer composite material, and is inserted in an easily produced cylindrical outer ring. As a result, the complicated production of a metallic outer ring through turning or forging is eliminated. In accordance with the invention, the components of the spherical bearing can be assembled in the manner of an assembly kit, in order to efficiently produce various variations of a spherical bearing. The outer ring can have a rim, in particular when it is a thin, deep-drawn outer ring. The rim is then produced directly in the deep-drawing procedure. Alternatively, a thicker outer ring in the form of a forged tube may be used, which is caulked at one end after the components have been inserted.

The production process according to embodiments of the invention is particularly well suited for mass production, because the components needed for the spherical bearing can be easily and inexpensively produced.

It is particularly preferred that a radial or axial sliding body is used with the method according to embodiments of the invention. The division of the sliding body simplifies the assembly of the components, in particular the convex curved inner ring and the outer ring. The divided sliding body preferably comprises two parts of equal size, but it can also be divided asymmetrically. Alternatively, a one-piece slotted sliding body can be used, which can be deformed in an elastic manner for the assembly, i.e. the insertion of the inner ring.

With the method according to this disclosure, the sliding body may be glued to the outer ring. The two parts of the sliding body are glued to the outer ring during the assembly of the components, by means of which an outer ring is formed, which is comparable to a conventional outer ring produced through turning or forging. The sliding body may be produced in the method according to this disclosure with an injection molding process. In this manner, a particularly cost-efficient production, suitable for mass production, is possible.

In the framework of this disclosure, it may also be provided that the outer ring is knurled on its inner surface, or blasted with a blasting agent. In this manner, the surface area serving as the adhesive surface is enlarged, and the adhesion is improved. The inner surface of the outer ring can be sandblasted, for example, and an adhesive can be subsequently applied to the sandblasted surface, in order to glue the two-piece sliding body to the outer ring.

In the methods of this disclosure, a polymer material or a polymer composite material can be sprayed on, in order to create a seal against dirt and moisture. At least one groove for a lubricant can be generated in the sliding body, preferably in the injection molding process. The outer diameter of the two-piece sliding body is selected such that it has a surface structure, by means of which the dimensional tolerances can be compensated for, and which enables a gluing to the outer ring. With the gluing of the two-piece sliding body to the outer ring on or by means of an appropriate device, which positions the components that are to be glued in relation to one another, tolerances of the outer ring and the two-piece sliding body can be compensated for.

Furthermore, this disclosure relates to a spherical bearing, having an inner ring with a convex curved sliding surface, and an outer ring that encompasses the inner ring. The spherical bearing according to this disclosure is distinguished in that it has a two-piece sliding body made of a polymer composite material, which is inserted into the cylindrical outer ring.

With the spherical bearing according to the invention, the two-piece sliding body can be divided axially or radially.

The polymer composite material of the spherical bearing according to this disclosure preferably includes at least one filler material from the following group: glass fibers, carbon fibers, aramid fibers, hemp fibers, flax fibers, cotton fibers. The stability of the polymer composite material is increased by the at least one filler material. The lengths and proportion of the respective fibers that are used are selected such that the production of the sliding body from the polymer composite material can take place in an injection molding process.

With particular advantage, it may be provided with the spherical bearing according to this disclosure, that the polymer composite material includes at least one filler material from the following group: MoS2, talcum, TiO2, graphite, PTFE (polytetrafluoroethylene), silica, silicone oil, ceramic. The selected filler material(s) reduce the friction and wear, and form an active surface, which can also be applied to the inner ring of the spherical bearing. The polymer composite material can have a gradient structure.

It is also within the scope of this disclosure that the two-piece sliding body of the spherical bearing according to the invention has at least one groove for a lubricant. The groove filled with the lubricant ensures a distribution of the lubricant when the spherical bearing moves. The groove, however, is an optional feature, which may be provided with spherical bearing requiring maintenance. With maintenance-free spherical bearings, the groove can be omitted.

In the spherical bearing according to this disclosure, the outer ring can be produced through deep-drawing or forging a tube, and can be knurled on its inner surface, or can have a surface that has been blasted with a blasting agent.

### BRIEF DESCRIPTION OF THE DRAWINGS

The invention shall be explained below based on exemplary embodiments, with reference to the drawings. The drawings are schematic illustrations. Therein:

FIG. 1 shows the components of a spherical bearing according to the invention, prior to assembly;

FIG. 2 shows a bisected view of the assembled spherical bearing;

FIG. 3 shows the individual components of a spherical bearing according to the invention in accordance with a second exemplary embodiment, prior to assembly;

FIG. 4 shows the spherical bearing after assembly, in a bisected view;

FIG. 5 shows the components of a spherical bearing according to the invention in accordance with third exemplary embodiment, prior to assembly; and

FIG. 6 shows the spherical bearing shown in FIG. 5, after assembly.

### DETAILED DESCRIPTION

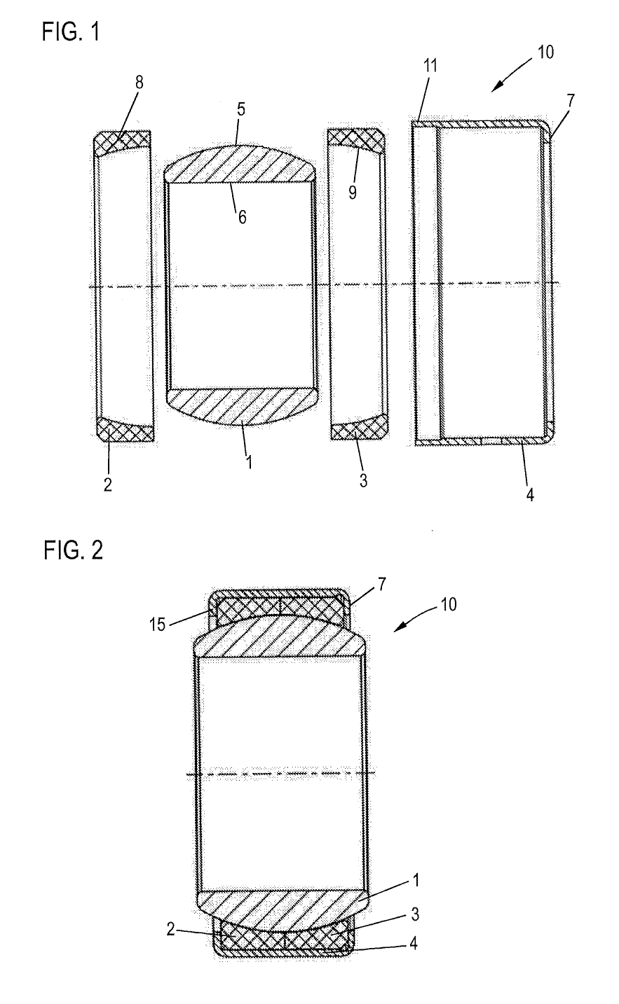

FIG. 1 shows the individual components of a spherical bearing 10, comprising an inner ring 1, a two-piece sliding body 2, 3, and an outer ring 4. The inner ring 1 has a convex curved spherical sliding surface 5, and is provided with a cylindrical bore 6 on the inside. The inner ring 1 is produced in accordance with a conventional production process, through turning.

The outer ring 4 is formed as a cylindrical sleeve, and produced from a thin-walled steel tube through deep-drawing. On one side, the outer ring has a rim 7, formed during deep-drawing. The two parts of the two-piece sliding body 2, 3 are produced from a polymer composite material. In the depicted exemplary embodiment, this is polyamide (PA66), which is reinforced with glass fibers to increase the stability. The two-piece sliding body 2, 3 is produced in an injection molding process. In addition, it comprises PTFE (polytetrafluoroethylene) as a filler material, by means of which the friction is reduced. The two-piece sliding body 2, 3 has inner surfaces 8, 9, which correspond to the convex curved spherical sliding surface 5. The assembly of the spherical bearing 10, shown in FIG. 2 in a bisected view, takes place in that the radially divided sliding body 2, 3 and the inner ring 1 are inserted in the sequence shown in FIG. 1 into the outer ring 4 forming a sleeve. The free end 11 of the outer ring is subsequently folded over, by means of which the rim 15 shown in FIG. 2 is formed. Prior to assembly, the two-piece sliding body 2, 3 is provided with a lubricant. Prior to inserting the sliding body 2, 3 into the outer ring 4, the knurled inner surfaces 8, 9 of the outer ring is provided with an adhesive in this exemplary embodiment, such that the two-piece sliding body 2, 3 is glued to the outer ring 4 during assembly. The assembly takes place by means of an appropriate device, that aligns all of the components with one another.

By elastically deforming the outer ring 4 or the sliding body 2, 3, the effective bearing play of the spherical bearing 10 can be adjusted in a targeted manner. A negative bearing play can be modified by a thermal treatment of the spherical bearing 10 after the assembly, through a plastic deformation of the sliding body 23, to obtain a positive bearing play.

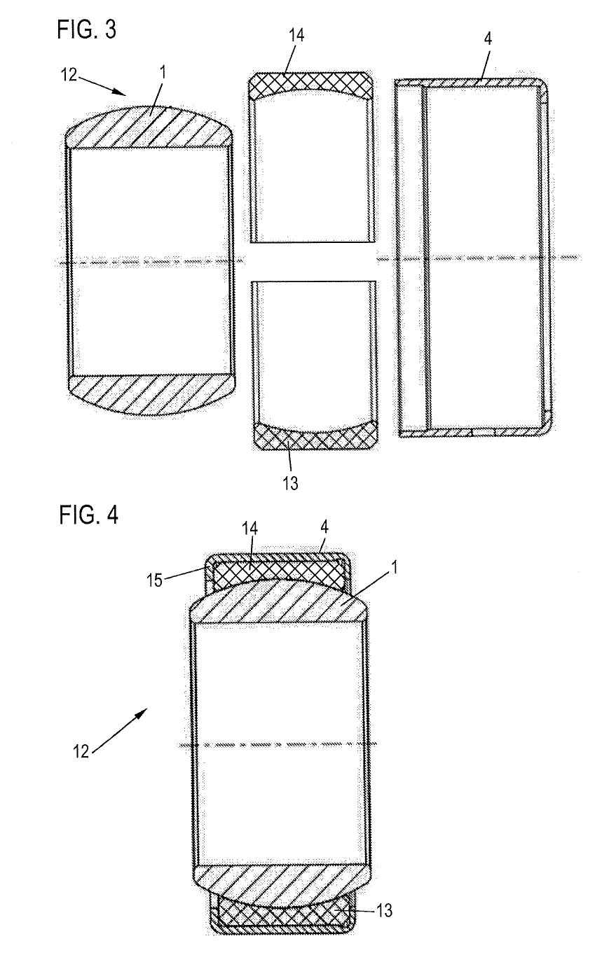

FIGS. 3 and 4 show a second exemplary embodiment of a spherical bearing 12, which has a similar construction to the spherical bearing 10 shown in FIGS. 1 and 2. As with the first exemplary embodiment, the spherical bearing 12 includes the inner ring 1 and the outer ring 4. Deviating therefrom, the spherical bearing 12 has a two-piece, axially divided sliding body 13, 14. The two sliding bodies 13, 14 are thus formed as half-rings, each of which extends over a semicircle. The two sliding bodies 13, 14 are composed of a polymer composite material, a polyamide in this exemplary embodiment, reinforced with glass fibers. In addition, the polymer composite material comprises PTFE as a friction reducing and surface-active filler material.

For the assembly, the inner ring 1 is encompassed on the outside by the two parts of the two-piece, axially divided sliding body 13, 14, and this preassembled assembly is then inserted into the outer ring 4 formed as a sleeve. In a manner analogous to the first exemplary embodiment, the outer ring 4 is folded over after the inner ring 1 has been inserted, such that the rim 15 is obtained.

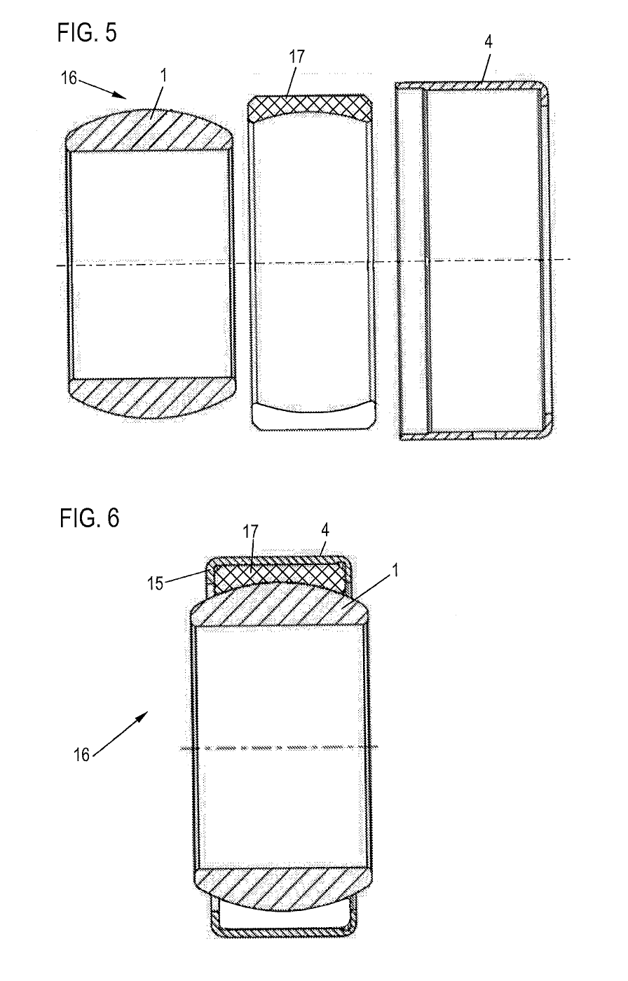

FIGS. 5 and 6 show a third exemplary embodiment of a spherical bearing 16, wherein FIG. 5 shows the individual components in a bisected view, prior to assembly, and FIG. 6 shows the spherical bearing 16 after assembly.

The spherical bearing 16 comprises the inner ring 1, the outer ring 4, and—in deviating from the preceding exemplary embodiments—a one-piece, slotted sliding body 17. The sliding body 17 is thus formed as a slotted ring, such that in the drawings, the slot is schematically depicted by the lower half without crosshatchings. The tangential extension of the slot is selected such that the sliding body 17 can be elastically deformed in order to be inserted in the inner ring 1, and after it has been inserted in the inner ring 1, the one-piece sliding body 17 reassumes its original shape. Subsequently, the preassembled assembly composed of the inner ring 1 and the one-piece sliding body 17 is inserted in the outer ring 4. The outer end of the outer ring 4 is subsequently folded over, such that the rim 15 is formed. In other exemplary embodiments, in which a forged tube is used instead of the thin-walled outer ring 4 shown in FIGS. 5 and 6, the free end of the tube is caulked after the inner ring and sliding body have been inserted.

The exemplary embodiment shown in FIGS. 5 and 6 has the advantage that the number of required parts is reduced. The slotted sliding body 17 can be inexpensively produced through injection molding. Because this is a maintenance-free spherical bearing, the sliding body 17 does not have a groove for lubricant.

The spherical bearing 10, 12, 16 can be mass-produced inexpensively with the method described herein.

### LIST OF REFERENCE SYMBOLS

1 inner ring

2, 3 sliding body

4 outer ring

5 sliding surface

6 bore

7 rim

8, 9 inner surface

10 spherical bearing

11 end

12 spherical bearing

13, 14 sliding body

15 rim

16 spherical bearing

17 sliding body

1. A method for producing a spherical bearing, having an inner ring with a convex curved spherical sliding surface, and a cylindrical outer ring encompassing the inner ring, the method comprising:
producing the inner ring from a metallic material;
producing a one-piece or two-piece sliding body from a polymer composite material;
producing the cylindrical outer ring from a metallic material; and
inserting the inner ring and the sliding body into the outer ring and caulking or folding over the outer ring to contain the sliding body within the outer ring.

2. The method according to claim 1, wherein the sliding body is a radially or axially divided two-piece sliding body or a one-piece slotted sliding body, is used.

3. The method according to claim 1, wherein the sliding body is glued to the outer ring.

4. The method according to claim 1, wherein the outer ring has an inner surface and the outer ring is knurled or blasted with a blasting agent on its inner surface.

5. A spherical bearing comprising:
an inner ring with a convex curved spherical sliding surface;
an outer ring encompassing the inner ring; and
a one-piece or two-piece sliding body made of a polymer composite material, which is inserted into the outer ring.

6. The spherical bearing according to claim 5, wherein the sliding body is two piece sliding body is divided axially or radially, or is slotted.

7. The spherical bearing according to claim 5, wherein the polymer composite material has at least one filler material from the following group: glass fibers, carbon fibers, aramid fibers, hemp fibers, flax fibers, cotton fibers.

8. The spherical bearing according to claim 5, wherein the polymer composite material has at least one filler material from the following group: MoS₂, talcum, TiO₂, graphite, PTFE (polytetrafluoroethylene), silica, silicone oil, ceramic.

9. The spherical bearing according to claim 5, wherein the sliding body has at least one groove for a lubricant.

10. The spherical bearing according to claim 5, wherein the outer ring is produced through deep-drawing or forging of a tube, and is knurled on an inner surface thereof, or has a surface that has been blasted with a blasting agent.

11. A spherical bearing comprising:
an inner ring having a convex outer surface;
a sliding body having a concave inner surface in contacting engagement with the convex outer surface to enable pivotal movement between the inner ring and the sliding body, the sliding body including a polymer composite material; and
an outer ring fixed about the sliding body.

12. The spherical bearing of claim 11, wherein the inner ring, the sliding body, and the outer ring define a common central axis, and the sliding body is a split-body that is split axially.

13. The spherical bearing of claim 11, wherein the inner ring, the sliding body, and the outer ring define a common central axis, and the sliding body is a split-body that is split radially.

14. The spherical bearing of claim 11, wherein the sliding body is single piece that is elastically deformable such that the sliding body is able to deform to fit over the inner ring during assembly.

15. The spherical bearing of claim 11, wherein the convex outer surface of the inner ring is partial-spherical in shape.

16. The spherical bearing of claim 11, wherein the sliding body includes a groove at least partially filled with lubricant.

17. The spherical bearing of claim 11, wherein the outer ring includes a first axial side having a first bent rim extending radially inwardly, and a second axial side having a second bent rim extending radially inwardly, wherein the first and second bent rims axially contain the sliding body.

18. The spherical bearing of claim 11, wherein the outer ring is fixed to the sliding body via an adhesive.
